(19) United States
(12) Patent Application Publication
(10) Pub. No.: US 2017/0211255 A1
(43) Pub. Date: Jul. 27, 2017

(54) HYDRAULIC EXCAVATOR

(71) Applicant: KOMATSU LTD., Tokyo (JP)

(72) Inventor: Tomoaki OZAKI, Komatsu-shi (JP)

(21) Appl. No.: 14/398,518

(22) PCT Filed: Aug. 8, 2014
(86) PCT No.: PCT/JP2014/071028

§ 371 Date: Nov. 3, 2014

(51) Int. Cl. E02F 3/32; B60K 13/04; F01N 3/20; E02F 9/22; E02F 9/08

(52) U.S. Cl. CPC E02F 3/32; E02F 9/22; E02F 9/0883; E02F 9/0833; F01N 3/2066; B60K 13/04; F01N 2610/1406

(57) ABSTRACT

A hydraulic excavator capable of improving accessibility to a pipe which forms a path connecting a reducing agent tank and an exhaust gas treatment device to each other is provided. The hydraulic excavator includes a pipe portion forming a path connecting the reducing agent tank and the exhaust gas treatment device to each other, a duct component member arranged along the pipe portion, and an openable and closable exterior cover forming a part of a lateral side surface of the body of the excavator. The exterior cover in the closed state and the duct component member form a duct portion which houses the pipe portion.

### TECHNICAL FIELD

The present invention relates to a hydraulic excavator.

### BACKGROUND ART

An exhaust gas treatment device is mounted on a hydraulic excavator. As the exhaust gas treatment device, for example, a diesel particulate filter device (DPF), a diesel oxidation catalyst device (DOC), a selective catalytic reduction device (SCR), and the like are available. In particular, the selective catalytic reduction device reduces a nitrogen oxide in an exhaust gas to thereby purify the exhaust gas. A reducing agent used for this exhaust gas treatment is stored in a reducing agent tank.

Japanese Patent Laying-Open No. 2014-80907 (PTD 1) discloses a structure in which a revolving frame supporting an engine includes a tubular frame and a reducing agent pipe which connects a reducing agent supply pump and a reducing agent injection apparatus to each other is arranged to extend inside the tubular frame.

### CITATION LIST

### Patent Document

### PTD 1: Japanese Patent Laying-Open No. 2014-80907

### SUMMARY OF INVENTION

### Technical Problem

In the case where the reducing agent is placed inside the enclosed tubular frame like PTD 1, the reducing agent pipe is difficult to install and consideration has to be given to access to the reducing agent pipe for the sake of maintenance.

An object of the present invention is to provide a hydraulic excavator capable of improving accessibility to a pipe forming a path connecting a reducing agent tank and an exhaust gas treatment device to each other.

### Solution to Problem

A hydraulic excavator of the present invention includes an engine, an exhaust gas treatment device, a reducing agent tank, a pipe, a duct component member, and an exterior cover. The exhaust gas treatment device treats an exhaust gas from the engine through a reduction reaction. The reducing agent tank is arranged forward of the exhaust gas treatment device. The reducing agent tank stores a reducing agent to be supplied to the exhaust gas treatment device. The pipe forms a path connecting the reducing agent tank and the exhaust gas treatment device to each other. The duct component member is arranged along the pipe. The exterior cover forms a part of a lateral side surface of a body of the excavator. The exterior cover is openable and closable. The exterior cover in a closed state and the duct component member form a duct portion which houses the pipe.

A reducing agent and a precursor of the reducing agent are herein collectively referred to as “reducing agent.”

Regarding the hydraulic excavator, the exterior cover can be opened to expose the pipe portion to the outside and improve accessibility to the pipe portion, which accordingly enables easy access to the pipe portion when maintenance work is necessary.

Regarding the hydraulic excavator, the duct portion is provided along the upper edge of the exterior cover in its closed state. Accordingly, the length of the path connecting the reducing agent tank and the exhaust gas treatment device to each other can be shortened.

The hydraulic excavator further includes a partition plate arranged rearward of the reducing agent tank. The partition plate defines a tank room housing the reducing agent tank. An internal space of the duct portion directly communicates with the tank room. Accordingly, the internal space of the duct portion can be kept at a low temperature, and a temperature increase of the reducing agent flowing through the pipe portion can be suppressed.

Regarding the hydraulic excavator, the duct component member has a vertical member and a horizontal member. The vertical member is opposite to the exterior cover with a space therebetween. The horizontal member is attached to a lower edge of the vertical member. In this way, the duct component member can be formed with a simple structure.

Regarding the hydraulic excavator, the exterior cover has a sheet-like plate portion. In the state where the exterior cover is closed, the plate portion forms the duct portion between the plate portion and the duct component member. In this way, the duct portion can simply be formed, and the duct portion can be made more compact in structure.

The hydraulic excavator is of a short tail swing type. In this case, the pipe portion in which the reducing agent flows can be housed inside the duct portion to thereby suppress heat transfer to the pipe portion and accordingly suppress deterioration of the reducing agent due to a temperature increase.

### Advantageous Effects of Invention

As seen from the foregoing, according to the present invention, the exterior cover can be opened to expose, to the outside, the pipe which forms the path connecting the reducing agent tank and the exhaust gas treatment device to each other, which accordingly enables easy access to the pipe.

### BRIEF DESCRIPTION OF DRAWINGS

FIG. 1 is a side view showing a structure of a hydraulic excavator according to one embodiment of the present invention.

FIG. 2 is a perspective view showing a partial structure of an upper revolving unit of the hydraulic excavator in FIG. 1.

FIG. 3 is a perspective view showing a structure of a front cover and tank covers.

FIG. 4 is a schematic plan view showing arrangement of each device on a revolving frame.

FIG. 5 is a functional diagram schematically showing a path for a reducing agent, a path for a medium for use in heat exchange, and an exhaust path for an exhaust gas from an engine.

FIG. 6 is a hydraulic circuit diagram applied to a hydraulic excavator.

FIG. 7 is a perspective view showing a state where an exterior cover is opened.

FIG. 8 is a schematic diagram showing a state where the exterior cover is opened as seen laterally.

FIG. 9 is a perspective view of the exterior cover.

FIG. 10 is a bottom view of the exterior cover.

FIG. 11 is a schematic diagram showing a structure of a duct portion which houses a pipe portion.

### DESCRIPTION OF EMBODIMENTS

An embodiment of the present invention will be described hereinafter with reference to the drawings.

Initially, a structure of a hydraulic excavator to which the concept according to the present invention is applicable will be described.

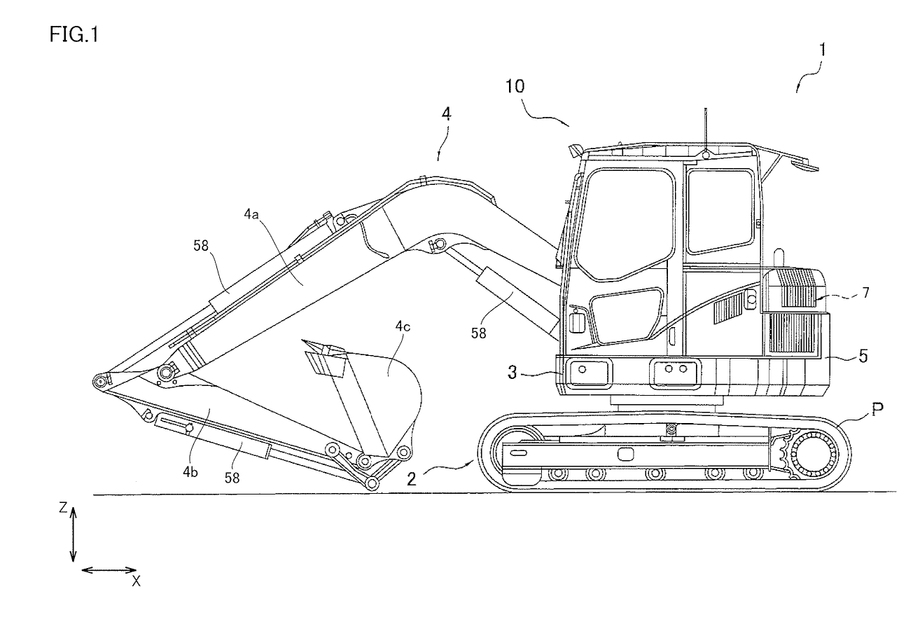

FIG. 1 is a side view showing a structure of a hydraulic excavator according to one embodiment of the present invention. Hydraulic excavator 1 according to the present embodiment mainly includes a lower carrier 2, an upper revolving unit 3, a work implement 4, a counterweight 5, an engine 7, and a cab 10, as shown in FIG. 1.

A main body of the hydraulic excavator is mainly constituted of lower carrier 2 and upper revolving unit 3.

Lower carrier 2 has a pair of crawler belts P wound around left and right opposing end portions in a direction of travel. Lower carrier 2 is structured to be self-propelled as the pair of crawler belts P rotates.

Upper revolving unit 3 is set to be revolvable in any direction with respect to lower carrier 2. Upper revolving unit 3 includes, on a front left side, cab 10 which is an operator's cab that an operator of hydraulic excavator 1 gets on and off. Upper revolving unit 3 includes, on a rear side, counterweight 5 and an engine compartment for accommodating engine 7.

In the present embodiment, the forward side (front side) of a driver seated in cab 10 is defined as the forward side of upper revolving unit 3, the rear side of the driver seated therein is defined as the rear side of upper revolving unit 3, the left side of the driver in the seated state is defined as the left side of upper revolving unit 3, and the right side of the driver in the seated state is defined as the right side of upper revolving unit 3. In the description below, fore, aft, left, and right of upper revolving unit 3 correspond to fore, aft, left, and right of hydraulic excavator 1, respectively. In the drawings below, the fore/aft direction is shown with an arrow X in the drawings, the lateral direction is shown with an arrow Y in the drawings, and the vertical direction is shown with an arrow Z in the drawings.

Work implement 4 for such work as excavation of soil is pivotally supported by upper revolving unit 3 so as to be freely operable in the vertical direction. Work implement 4 has a boom 4a attached to be operable in the vertical direction in a substantially central portion on the forward side of upper revolving unit 3, an arm 4b attached to be operable in the fore/aft direction at the leading end of boom 4a, and a bucket 4c attached to be operable in the fore/aft direction at the leading end of arm 4b. Boom 4a, arm 4b, and bucket 4c are each configured to be driven by a hydraulic cylinder 58.

Work implement 4 is provided on the right side of cab 10, which is one lateral side of cab 10, such that an operator who is aboard cab 10 can view the leading end of work implement 4. Cab 10 is arranged laterally with respect to a portion where work implement 4 is attached.

Counterweight 5 is a weight arranged in the rear portion of upper revolving unit 3 for keeping balance of the excavator's body during excavation or the like. Hydraulic excavator 1 is formed as a short tail swing hydraulic excavator, which is small in radius of swing of a rear surface of counterweight 5. Therefore, the rear surface of counterweight 5 is formed in an arc shape around a center of swing of upper revolving unit 3 when viewed from above. Engine 7 is accommodated in the engine compartment in the rear portion of upper revolving unit 3.

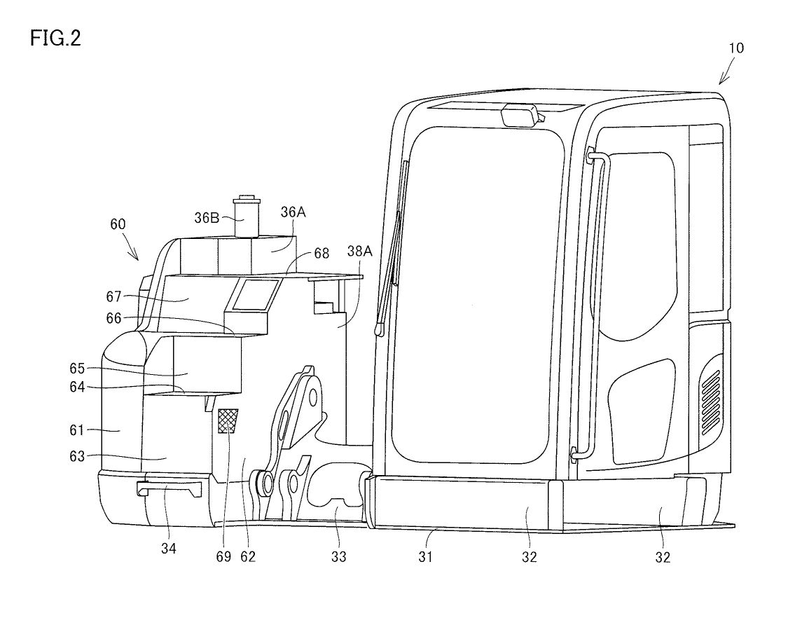

FIG. 2 is a perspective view showing a partial structure of upper revolving unit 3 of hydraulic excavator in FIG. 1. In FIG. 2, a part of the structure of upper revolving unit 3 of hydraulic excavator 1 shown in FIG. 1, as seen from the front left side, is illustrated. As shown in FIG. 2, upper revolving unit 3 has a revolving frame 31. Revolving frame 31 is included in the main body of the hydraulic excavator. Revolving frame 31 is arranged above lower carrier 2 shown in FIG. 1, and provided to freely revolve in any direction with respect to lower carrier 2.

On the upper surface of revolving frame 31, a pair of floor frames 32, 32 is arranged in the fore/aft direction with a space therebetween. Cab 10 is placed on floor frames 32, 32. Cab 10 is mounted on revolving frame 31 with floor frames 32 interposed therebetween.

At the front end of a central portion in the lateral direction of revolving frame 31, a center bracket 33 is provided. The proximal end of work implement 4 shown in FIG. 1 is attached to center bracket 33. Center bracket 33 supports work implement 4 of hydraulic excavator 1, and forms the portion where work implement 4 is attached.

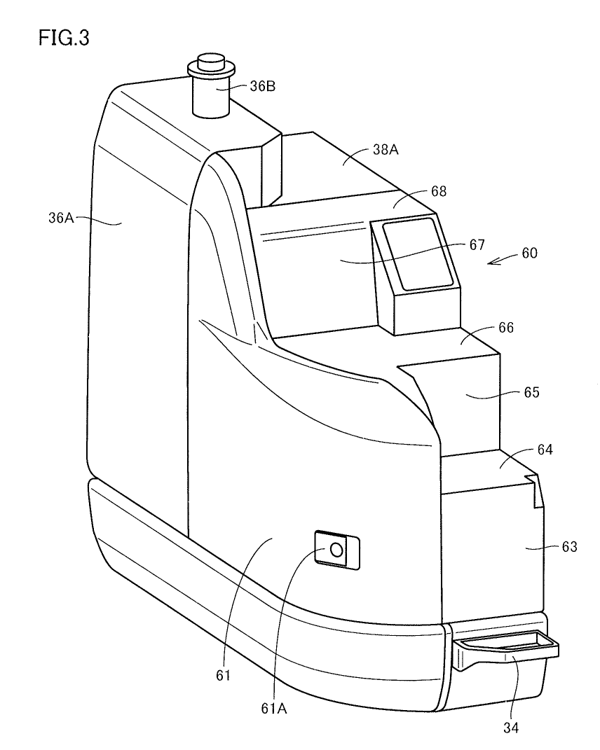

At a right forward side of revolving frame 31, a front cover 60 is arranged. Tank covers 36A, 38A are arranged rearward with respect to front cover 60. FIG. 3 is a perspective view showing a structure of front cover 60 and tank covers 36A, 38A. In front cover 60, a tank room 92 and a valve room 97 which will be described later herein are formed. In tank cover 36A, a fuel tank 36 which will be described later herein is housed. In the upper surface of tank cover 36A, a filler port 36B is provided for replenishing fuel tank 36 with a fuel. In tank cover 38A, a hydraulic oil tank 38 which will be described later herein is housed.

Front cover 60 has an exterior cover 61 and a left side plate 62. Exterior cover 61 forms the right side of front cover 60 and forms a part of a lateral side of the main body of the hydraulic excavator. Exterior cover 61 extends from the front end of tank cover 36A toward the front end of upper revolving unit 3. Exterior cover 61 is provided so that it is openable and closable. Exterior cover 61 has a handle 61A. A serviceperson can hold handle 61A of exterior cover 61 in a closed state to pivot exterior cover 61 and thereby open exterior cover 61.

Left side plate 62 shown in FIG. 2 forms the left side of front cover 60. Left side plate 62 is opposite to exterior cover 61 with some components such as a reducing agent tank 20 and a main valve 57, which will be described later herein, interposed therebetween. Left side plate 62 is opposite to the right side of cab 10 with center bracket 33 interposed therebetween. Left side plate 62 extends in the fore/aft direction of upper revolving unit 3. In left side plate 62, a vent hole 69 is formed. Vent hole 69 allows tank room 92, which is formed inside front cover 60, and an external space of front cover 60 to communicate with each other.

Front cover 60 also has a front end plate 63, a lower step plate 64, a vertical plate 65, an upper step plate 66, a vertical plate 67, and a ceiling plate 68. Front cover 60 is provided between tank covers 36A, 38A and the front end of upper revolving unit 3.

Front end plate 63 is provided to extend in the vertical direction at the front end of upper revolving unit 3. Lower step plate 64 extends rearward from the upper edge of front end plate 63. Vertical plate 65 extends upward from the rear edge of lower step plate 64. Upper step plate 66 extends rearward from the upper edge of vertical plate 65. Vertical plate 67 extends upward from the rear edge of upper step plate 66. Ceiling plate 68 extends rearward from the upper edge of vertical plate 67. Ceiling plate 68 is arranged so that it is substantially coplanar with the upper surface of tank cover 38A.

A step 34 is provided to protrude forward from front end plate 63. Front end plate 63, lower step plate 64, vertical plate 65, upper step plate 66, vertical plate 67, and ceiling plate 68 constitute a shape of stairs. Placement of feet on step 34 and then on lower step plate 64 and upper step plate 66 of front cover 60 in this order enables easy access onto ceiling plate 68. Accordingly, a serviceperson can easily and safely perform work such as replenishment of fuel tank 36 with a fuel, oil supply to hydraulic oil tank 38, and maintenance of engine 7.

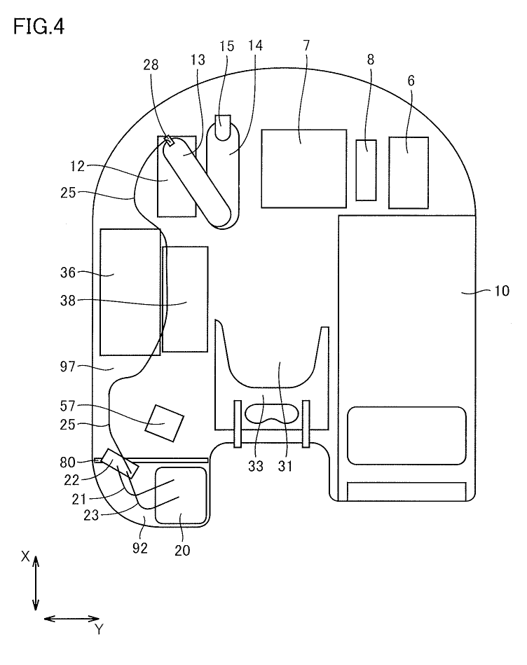

Next, a description will be given, with reference to FIG. 4, of a path of reducing agent piping from the reducing agent tank to an exhaust gas treatment unit in hydraulic excavator 1 of the present embodiment. FIG. 4 is a schematic plan view showing arrangement of each device on revolving frame 31. The lower side in FIG. 4 is the forward side of upper revolving unit 3 and the upper side in FIG. 4 is the rear side of upper revolving unit 3. FIG. 4 illustrates a path of piping (a supply pipe 21 and a delivery pipe 25) for supplying a reducing agent from reducing agent tank 20 to the exhaust gas treatment unit over revolving frame 31 in hydraulic excavator 1 shown in FIG. 1.

Engine 7 which is a motive power source for driving lower carrier 2 and work implement 4 shown in FIG. 1 is mounted on revolving frame 31. Engine 7 is mounted on a rear portion of a center frame located at the center in the lateral direction of revolving frame 31. Engine 7 which is large in weight is arranged at the rear end of the main body of the hydraulic excavator, which is distant from center bracket 33 supporting work implement 4 and is close to counterweight 5, in consideration of weight balance with work implement 4 attached to the front of the main body of the hydraulic excavator. The engine compartment accommodating engine 7 is provided in the rear portion of upper revolving unit 3.

The engine compartment accommodates a cooling unit 6 and a fan 8. In the engine compartment, cooling unit 6, fan 8, and engine 7 are disposed in this order from left to right. Fan 8 is rotationally driven by engine 7 so as to generate a flow of air which passes through the engine compartment. Fan 8 generates a flow of air from the left to the right of the main body of the hydraulic excavator. Cooling unit 6 is arranged on the left of fan 8, which is upstream in the flow of air generated by fan 8. Engine 7 is arranged on the right of fan 8, which is downstream in the flow of air generated by fan 8.

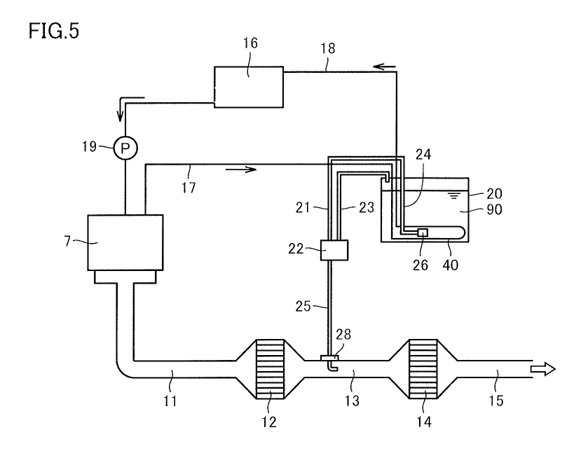

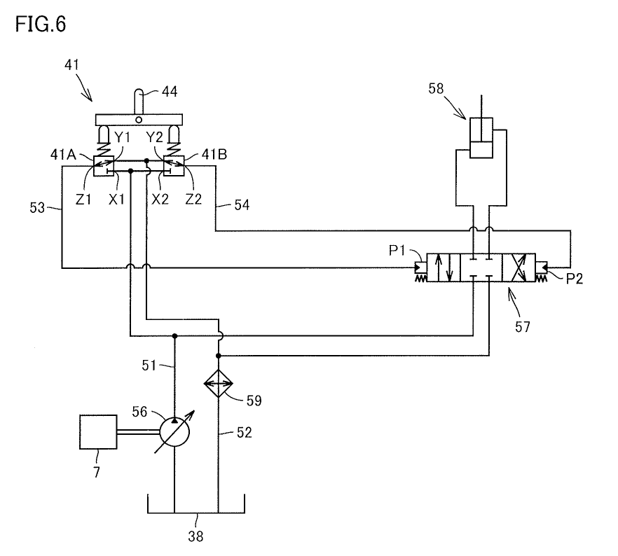

Cooling unit 6 is structured to include a radiator 16 (FIG. 5) which will be described later herein, an intercooler, and an oil cooler 59 (FIG. 6) which will be described later herein. Radiator 16 is a cooling device for cooling a coolant for engine 7. The intercooler is a cooling device for cooling compression air supplied to engine 7. Oil cooler 59 is a cooling device for cooling a hydraulic oil supplied to various hydraulic actuators mounted on hydraulic excavator 1, such as hydraulic cylinder 58 (FIG. 1).

Hydraulic excavator 1 also includes in the engine compartment, an exhaust gas treatment unit for treating and purifying an exhaust gas emitted from engine 7. The exhaust gas treatment unit mainly includes exhaust gas treatment devices 12 and 14, an intermediate connection pipe 13, an exhaust stack 15, and an injection nozzle 28 for a reducing agent. In the plan view shown in FIG. 4, the exhaust gas treatment unit is arranged on the right of engine 7. A hydraulic pump 56 (see FIG. 6, not shown in FIG. 4) driven by engine 7 to transfer a hydraulic oil is directly coupled to engine 7. Hydraulic pump 56 is arranged adjacently on the right of engine 7 and the exhaust gas treatment unit is arranged above hydraulic pump 56.

Exhaust gas treatment device 12 is connected to engine 7 through an exhaust pipe 11 (FIG. 5) which will be described later herein. Exhaust gas treatment device 14 is connected to exhaust gas treatment device 12 through intermediate connection pipe 13. The exhaust gas emitted from engine 7 is passed successively through exhaust gas treatment devices 12 and 14 and emitted from exhaust stack 15 into atmosphere. In the flow of emission of the exhaust gas from engine 7, exhaust gas treatment device 12 is arranged downstream of engine 7 and exhaust gas treatment device 14 is arranged downstream of exhaust gas treatment device 12.

Exhaust gas treatment device 12 oxidizes an unburned gas such as carbon monoxide and hydrocarbon contained in the exhaust gas emitted from engine 7 so as to lower a concentration of the unburned gas in the exhaust gas. Exhaust gas treatment device 12 is a diesel oxidation catalyst device, for example. Exhaust gas treatment device 14 reduces a nitrogen oxide contained in the exhaust gas through reaction with a reducing agent and chemically changes the nitrogen oxide to a harmless nitrogen gas, to thereby lower a concentration of the nitrogen oxide in the exhaust gas. Exhaust gas treatment device 14 is an NOₓ removal device of a selective catalytic reduction type, for example. Intermediate connection pipe 13 is provided with injection nozzle 28 for injecting a reducing agent into intermediate connection pipe 13. Intermediate connection pipe 13 has a function as a mixing pipe for injecting and mixing the reducing agent into the exhaust gas.

Hydraulic excavator 1 also includes a reducing agent supply portion for supplying a reducing agent to the exhaust gas treatment unit. The reducing agent supply portion includes reducing agent tank 20 and a reducing agent pump 22. Reducing agent tank 20 stores a reducing agent used in exhaust gas treatment device 14. For example, a urea solution is suitably employed as the reducing agent. The reducing agent, however, is not limited thereto.

Reducing agent tank 20 and reducing agent pump 22 are mounted on a right side frame of revolving frame 31. Reducing agent pump 22 is arranged forward relative to the engine compartment. Reducing agent tank 20 is arranged forward relative to reducing agent pump 22. Reducing agent tank 20 is arranged at a distance from engine 7 which is a device at a high temperature, for prevention of deterioration of the reducing agent due to a temperature increase thereof, and it is arranged, for example, at the front end of revolving frame 31.

Reducing agent tank 20 and reducing agent pump 22 are coupled to each other through supply pipe 21 and a return pipe 23. Supply pipe 21 is a pipe for sending the reducing agent from reducing agent tank 20 to reducing agent pump 22. Return pipe 23 is a pipe for returning the reducing agent from reducing agent pump 22 to reducing agent tank 20. Reducing agent pump 22 and injection nozzle 28 are coupled to each other through delivery pipe 25. Delivery pipe 25 is a pipe for transferring the reducing agent from reducing agent pump 22 to injection nozzle 28.

The reducing agent transferred from reducing agent tank 20 through supply pipe 21 to reducing agent pump 22 is branched into two in reducing agent pump 22. The reducing agent not used for exhaust gas treatment is returned from reducing agent pump 22 through return pipe 23 to reducing agent tank 20. The reducing agent used for exhaust gas treatment reaches injection nozzle 28 from reducing agent pump 22 through delivery pipe 25 and is sprayed from injection nozzle 28 into intermediate connection pipe 13.

The exhaust gas from engine 7 flows into exhaust gas treatment device 14 through intermediate connection pipe 13. Intermediate connection pipe 13 is provided upstream of exhaust gas treatment device 14 in the flow of the exhaust gas. The reducing agent suctioned from reducing agent tank 20 is injected into the exhaust gas which flows through intermediate connection pipe 13, through injection nozzle 28 attached to intermediate connection pipe 13. The reducing agent is injected into the upstream side of exhaust gas treatment device 14 in the flow of the exhaust gas. An amount of the reducing agent injected into the exhaust gas is controlled based on a temperature of the exhaust gas which passes through exhaust gas treatment device 14 and a concentration of a nitrogen oxide in the exhaust gas.

Reducing agent tank 20 is arranged at the front end on revolving frame 31 and exhaust gas treatment device 14 is arranged at the rear end on revolving frame 31. With this arrangement, supply pipe 21 and delivery pipe 25 for transferring the reducing agent extend in the fore/aft direction of the main body of the hydraulic excavator and extend from the front end toward the rear end of revolving frame 31.

On the right side frame of revolving frame 31, fuel tank 36, hydraulic oil tank 38, and main valve 57 are also mounted. Fuel tank 36 stores a fuel to be supplied to engine 7. Hydraulic oil tank 38 stores a hydraulic oil to be supplied to such a hydraulic actuator as hydraulic cylinder 58 (FIG. 1).

Since fuel tank 36 and hydraulic oil tank 38 are large in weight, they are arranged at positions located forward of the exhaust gas treatment unit, in consideration of weight balance on revolving frame 31. Taking into account operability in an operation for replenishing fuel tank 36 with a fuel, fuel tank 36 is arranged closer to a lateral side end of revolving frame 31 than hydraulic oil tank 38. Fuel tank 36 and hydraulic oil tank 38 are each formed as a pressure-resistant tank in a rectangular parallelepiped shape. The front surface of each of fuel tank 36 and hydraulic oil tank 38 is formed as a rear wall of valve room 97 accommodating main valve 57.

Main valve 57 is formed as an assembly of a large number of control valves, pilot valves, and the like. Main valve 57 supplies and discharges a hydraulic oil suctioned from hydraulic oil tank 38 and transferred by hydraulic pump 56 (FIG. 6) to and from such a hydraulic actuator as hydraulic cylinder 58 shown in FIG. 1, as well as a motor for travel and a motor for swing which are not shown. Thus, main valve 57 actuates the body of hydraulic excavator 1 and work implement 4 in response to an operation by an operator.

Since main valve 57 is smaller in weight than fuel tank 36 and hydraulic oil tank 38, it is arranged forward with respect to fuel tank 36 and hydraulic oil tank 38, in consideration of weight balance on revolving frame 31. Main valve 57 is arranged rearward with respect to reducing agent tank 20.

Valve room 97 accommodating main valve 57 and tank room 92 accommodating reducing agent tank 20 are partitioned off from each other by a partition plate 80. Partition plate 80 is arranged rearward with respect to reducing agent tank 20 and forward with respect to main valve 57, and arranged between reducing agent tank 20 and main valve 57. Partition plate 80 is interposed between reducing agent tank 20 and main valve 57 in the fore/aft direction of upper revolving unit 3.

Partition plate 80 is formed as a front wall of valve room 97. Partition plate 80 is formed as a rear wall of tank room 92. A front wall of tank room 92 is formed by front end plate 63 shown in FIGS. 2 and 3. A right sidewall of tank room 92 is formed by exterior cover 61 in the closed state shown in FIG. 3. A left sidewall of tank room 92 is formed by left side plate 62 shown in FIG. 2.

Exterior cover 61, left side plate 62, front end plate 63, and partition plate 80 constitute a wall portion defining tank room 92. Of the wall portion defining tank room 92, only partition plate 80 which is the rear wall portion is interposed between main valve 57 and reducing agent tank 20. Of the wall portion defining tank room 92, left side plate 62 which is a left wall portion has vent hole 69 (FIG. 2) formed therein. Vent hole 69 is formed to serve as a communication hole allowing the inside and the outside of tank room 92 to communicate with each other.

Reducing agent tank 20 is arranged at a corner of tank room 92 as seen in a plan view, in a front portion in tank room 92. Reducing agent tank 20 is formed substantially in a rectangular parallelepiped shape. The front surface of reducing agent tank 20 is opposite to front end plate 63 with a slight gap between the front surface and front end plate 63. The left surface of reducing agent tank 20 is opposite to left side plate 62 with a slight gap between the left surface and left side plate 62. Reducing agent tank 20 is arranged relatively closer to the front wall of tank room 92 than to the rear wall thereof.

At the corner formed by front end plate 63 and left side plate 62, reducing agent tank 20 is arranged. As shown in FIGS. 2 and 3, a front end portion of exterior cover 61 is curved. Therefore, reducing agent tank 20 which is rectangular as seen in a plan view is arranged adjacently to left side plate 62 to thereby enable reducing agent tank 20 to be located closer to the wall portion which defines tank room 92.

FIG. 5 is a functional diagram schematically showing a path for the reducing agent, a path for a medium for use in heat exchange, and an exhaust path for the exhaust gas from engine 7 in hydraulic excavator 1 of the present embodiment. As shown in FIG. 5, the exhaust gas emitted from engine 7 is passed successively through exhaust pipe 11, exhaust gas treatment device 12, intermediate connection pipe 13, and exhaust gas treatment device 14 and then exhausted from exhaust stack 15 to the outside of the hydraulic excavator. Injection nozzle 28 is provided in intermediate connection pipe 13 located upstream of exhaust gas treatment device 14 in the flow of the exhaust gas.

A reducing agent 90 is stored in reducing agent tank 20. A suction pipe 24 in which reducing agent 90 which flows out of reducing agent tank 20 flows is arranged in reducing agent tank 20. A strainer (filter) 26 is connected to the leading end of suction pipe 24. Suction pipe 24 is coupled to supply pipe 21. Reducing agent 90 suctioned from reducing agent tank 20 is transferred by reducing agent pump 22 and reaches injection nozzle 28 after successively passed through supply pipe 21 and delivery pipe 25. Reducing agent 90 not used for exhaust gas treatment is returned to reducing agent tank 20 from reducing agent pump 22 through return pipe 23.

Injection nozzle 28 has a function as a reducing agent injector for injecting reducing agent 90 suctioned from reducing agent tank 20 to the upstream side of the exhaust gas relative to exhaust gas treatment device 14. Injection nozzle 28 supplies reducing agent 90 into the exhaust gas which flows through intermediate connection pipe 13. The concentration of a nitrogen oxide in the exhaust gas lowers as a result of reaction of the nitrogen oxide contained in the exhaust gas with reducing agent 90 in exhaust gas treatment device 14. In a case that a urea solution is employed as reducing agent 90, the urea solution is decomposed in intermediate connection pipe 13 and converted to ammonia, so that the nitrogen oxide is decomposed to harmless nitrogen and oxygen as a result of reaction between the nitrogen oxide and ammonia. An exhaust gas in which the amount of nitrogen oxide has lowered to an appropriate value is emitted through exhaust stack 15.

In reducing agent tank 20, a heat exchanger 40 is arranged through which a medium for heat exchange with reducing agent 90 (heat exchange medium) flows. As the heat exchange medium, a coolant for engine 7 is used. Heat exchanger 40 has a first conduit directing the heat exchange medium into reducing agent tank 20, and a second conduit for flowing the heat exchange medium out of reducing agent tank 20. The first conduit is coupled to a coolant pipe 17. The second conduit is coupled to a coolant pipe 18. On coolant pipe 18, radiator 16 and a coolant pump 19 are provided.

Coolant pump 19 is driven to cause the coolant for engine 7 to circulate through engine 7, heat exchanger 40, radiator 16, and coolant pump 19. The coolant heated by engine 7 exchanges its heat with reducing agent 90 in heat exchanger 40 to be accordingly cooled. Meanwhile, reducing agent 90 receives heat from the coolant to be accordingly heated. Radiator 16 is a heat exchanger for exchanging heat between the coolant and air to cool the coolant. The coolant cooled in radiator 16 flows in a water jacket of engine 7 to appropriately cool engine 7.

FIG. 6 is a hydraulic circuit diagram applied to hydraulic excavator 1 in FIG. 1. In a hydraulic system of the present embodiment shown in FIG. 6, hydraulic pump 56 is directly coupled to engine 7. Hydraulic pump 56 is driven by engine 7 to serve as a drive source for driving hydraulic actuators such as hydraulic cylinder 58 for driving work implement 4 shown in FIG. 1. The hydraulic oil delivered from hydraulic pump 56 is supplied to hydraulic cylinder 58 through main valve 57. The hydraulic oil supplied to hydraulic cylinder 58 is discharged to hydraulic oil tank 38 through main valve 57. Hydraulic oil tank 38 stores the hydraulic oil therein.

Main valve 57 controls supply and discharge of the hydraulic oil to hydraulic cylinder 58. Main valve 57 has a pair of pilot ports p1, p2. The hydraulic oil having a predetermined pilot pressure is supplied to each of pilot ports p1, p2 to thereby control main valve 57.

The pilot pressure applied to main valve 57 is controlled through an operation of an operation lever device 41. Operation lever device 41 has an operation lever 44 operated by an operator, and a first pilot pressure control valve 41A and a second pilot pressure control valve 41B. To operation lever 44, pilot pressure control valves 41A, 41B are connected for controlling driving of hydraulic cylinder 58.

First pilot pressure control valve 41A has a first pump port X1, a first tank port Y1, and a first supply/discharge port Z1. First pump port X1 is connected to a pump flow passage 51. First tank port Y1 is connected to a tank flow passage 52. Pump flow passage 51 and tank flow passage 52 are connected to hydraulic oil tank 38. Hydraulic pump 56 is provided on pump flow passage 51. First supply/discharge port Z1 is connected to a first pilot conduit 53.

First pilot pressure control valve 41A is switched between an output state and a discharge state in response to an operation of operation lever 44. First pilot pressure control valve 41A in the output state causes first pump port X1 and first supply/discharge port Z1 to communicate with each other and outputs the hydraulic oil having a pressure, which is determined by the amount of the operation of operation lever 44, from first supply/discharge port Z1 to first pilot conduit 53. First pilot pressure control valve 41A in the discharge state causes first tank port Y1 and first supply/discharge port Z1 to communicate with each other.

Second pilot pressure control valve 41B has a second pump port X2, a second tank port Y2, and a second supply/discharge port Z2. Second pump port X2 is connected to pump flow passage 51. Second tank port Y2 is connected to tank flow passage 52. Second supply/discharge port Z2 is connected to a second pilot conduit 54.

Second pilot pressure control valve 41B is switched between an output state and a discharge state in response to an operation of operation lever 44. Second pilot pressure control valve 41B in the output state causes second pump port X2 and second supply/discharge port Z2 to communicate with each other and outputs the hydraulic oil having a pressure, which is determined by the amount of the operation of operation lever 44, from second supply/discharge port Z2 to second pilot conduit 54. Second pilot pressure control valve 41B in the discharge state causes second tank port Y2 and second supply/discharge port Z2 to communicate with each other.

First pilot pressure control valve 41A and second pilot pressure control valve 41B constitute a pair and correspond to directions opposite to each other in which operation lever 44 is operated. For example, first pilot pressure control valve 41A corresponds to an operation of tilting operation lever 44 forward, and second pilot pressure control valve 41B corresponds to an operation of tilting operation lever 44 rearward. Operation lever 44 is operated to select one of first pilot pressure control valve 41A and second pilot pressure control valve 41B. When first pilot pressure control valve 41A is in the output state, second pilot pressure control valve 41B is in the discharge state. When first pilot pressure control valve 41A is in the discharge state, second pilot pressure control valve 41B is in the output state.

First pilot pressure control valve 41A controls supply and discharge of the hydraulic oil to first pilot port p1 of main valve 57. Second pilot pressure control valve 41B controls supply and discharge of the hydraulic oil to second pilot port p2 of main valve 57. In response to an operation of operation lever 44, supply and discharge of the hydraulic oil to hydraulic cylinder 58 are controlled and extension and retraction of hydraulic cylinder 58 are controlled. In this way, the motion of work implement 4 is controlled, following the operation of operation lever 44.

On tank flow passage 52 serving as a flow passage for the hydraulic oil flowing toward hydraulic oil tank 38, oil cooler 59 is provided. Oil cooler 59 is included in cooling unit 6 shown in FIG. 4. Oil cooler 59 cools the hydraulic oil discharged from first pilot pressure control valve 41A or second pilot pressure control valve 41B to return to hydraulic oil tank 38. Oil cooler 59 also cools the hydraulic oil discharged from main valve 57 to return to hydraulic oil tank 38. As shown in FIG. 6, oil cooler 59 has a function of cooling the hydraulic oil to be supplied to hydraulic cylinder 58.

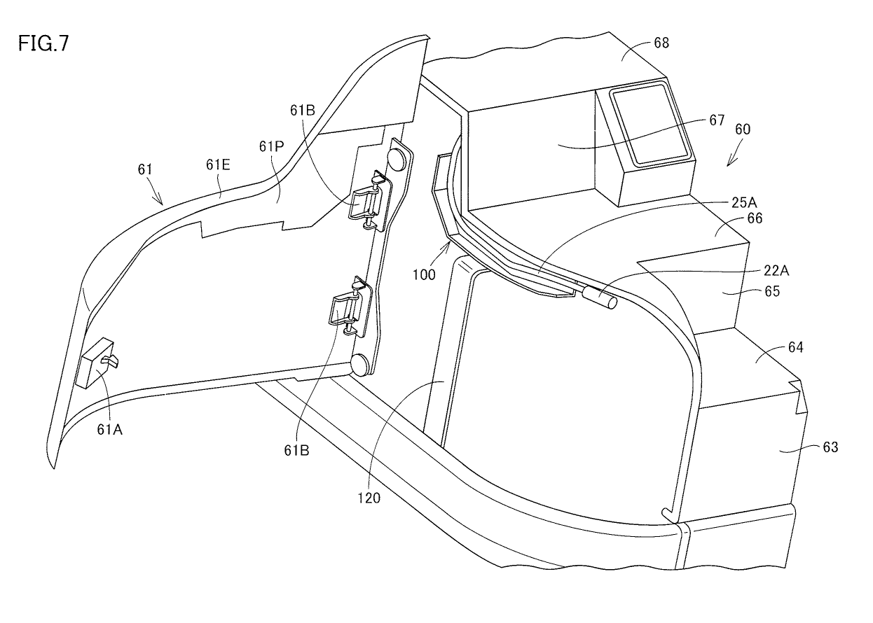

FIG. 7 is a perspective view showing a state where exterior cover 61 is opened. As shown in FIG. 7, exterior cover 61 has a pair of hinge portions 61B. Exterior cover 61 is attached by hinge portions 61B to a portion near the front surface of fuel tank 36 (FIG. 4) so that the cover is openable and closable.

In the state where exterior cover 61 is opened as shown in FIG. 7, respective lateral side surfaces of tank room 92 and valve room 97 are opened and reducing agent tank 20 and main valve 57 which are not shown in FIG. 7 are exposed to the outside. A serviceperson can open exterior cover 61 to easily access reducing agent tank 20 and main valve 57. The serviceperson can thus open exterior cover 61 to easily conduct work such as replenishment of reducing agent tank 20 with the reducing agent and maintenance of main valve 57.

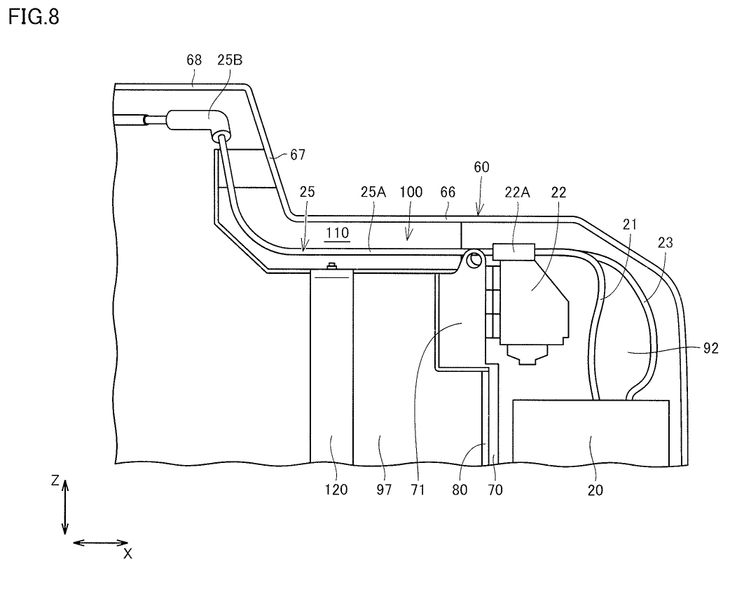

FIG. 8 is a schematic diagram showing a state where exterior cover 61 is opened as seen laterally. As shown in FIG. 8, a support column 70 is arranged rearward of the excavator's body (left side in FIG. 8) with respect to reducing agent tank 20. Support column 70 extends along the vertical direction. Support column 70 is arranged between reducing agent tank 20 and main valve 57 which is not shown in FIG. 8, in the fore/aft direction of the excavator's body. Support column 70 is secured to revolving frame 31 (FIGS. 2, 4).

A pump module including reducing agent pump 22 is arranged above reducing agent tank 20 in the vertical direction of the excavator's body. The pump module is attached to an attachment portion 71. Attachment portion 71 is secured to the upper end of support column 70. The pump module is supported by support column 70. The pump module is mounted on revolving frame 31 with support column 70 interposed therebetween.

Partition plate 80 is secured to support column 70 which supports the pump module, and partitions tank room 92 and valve room 97 off from each other. Partition plate 80 is arranged on the valve room 97 side with respect to support column 70, and extends in the vertical direction along support column 70. Partition plate 80 has a heat insulation effect. Partition plate 80 has a function of suppressing heat transfer to reducing agent tank 20 from a heat source which is arranged rearward with respect to reducing agent tank 20. The heat source arranged rearward with respect to reducing agent tank 20 includes engine 7, hydraulic oil tank 38, main valve 57, and fuel tank 36, for example.

The pump module has a coupling portion 22A coupling supply pipe 21 and delivery pipe 25 to reducing agent pump 22. The reducing agent suctioned from reducing agent tank 20 flows successively through supply pipe 21, reducing agent pump 22, and delivery pipe 25 toward injection nozzle 28 (FIGS. 4, 5). Coupling portion 22A is provided on reducing agent pump 22.

Delivery pipe 25 is arranged along upper step plate 66, vertical plate 67, and ceiling plate 68 of front cover 60. Delivery pipe 25 has a pipe portion 25A and a joint 25B. Pipe portion 25A forms a part of delivery pipe 25 that connects coupling portion 22A and joint 25B to each other. From coupling portion 22A, pipe portion 25A extends rearward of the excavator's body to joint 25B. Pipe portion 25A extends along upper step plate 66 of front cover 60 and further extends along vertical plate 67. Pipe portion 25A is arranged at a position close to front cover 60 and considerably far from revolving frame 31.

As shown in FIGS. 7 and 8, a duct component member 100 is attached to upper step plate 66 and vertical plate 67 of front cover 60. Front cover 60 and duct component member 100 form a part of the peripheral wall of a duct portion 110. Pipe portion 25A is housed in duct portion 110. Duct component member 100 is arranged along pipe portion 25A. Duct portion 110 is provided so that it is bent along a bent of front cover 60. Duct portion 110 extends in the fore/aft direction of the excavator's body along upper step plate 66 of front cover 60 and extends in the vertical direction along vertical plate 67 of front cover 60.

The upper surface of duct portion 110 extending along upper step plate 66 is formed by upper step plate 66 of front cover 60. Duct component member 100 forms the lower surface and one lateral wall of duct portion 110 extending along upper step plate 66. The front wall of duct portion 110 extending along vertical plate 67 is formed by vertical plate 67 of front cover 60. Duct component member 100 forms the rear wall and one lateral wall of duct portion 110 extending along vertical plate 67.

The end, on the forward side of the excavator, of duct component member 100 extends to the position of attachment portion 71 to which reducing agent pump 22 is attached. Accordingly, duct portion 110 communicates with tank room 92 housing reducing agent tank 20. Meanwhile, duct portion 110 is provided so that it does not communicate with valve room 97 housing main valve 57 (FIGS. 4, 6).

A support column 120 is provided that supports from below a part of duct component member 100 that is opposite to upper step plate 66. Support column 120 extends along the vertical direction. The lower end of support column 120 is secured to revolving frame 31 (FIGS. 2, 4). To the upper end of support column 120, duct component member 100 is secured. Duct component member 100 is mounted on revolving frame 31 with support column 120 interposed therebetween.

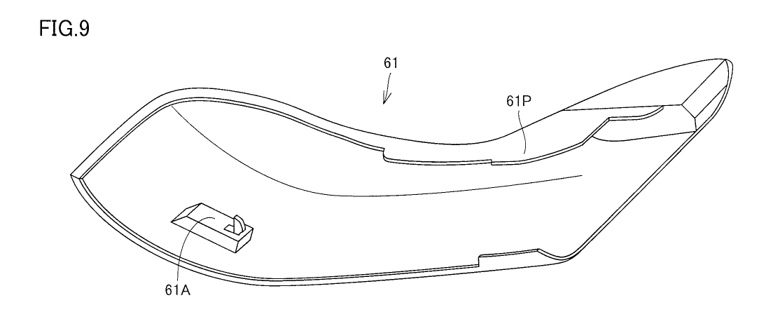

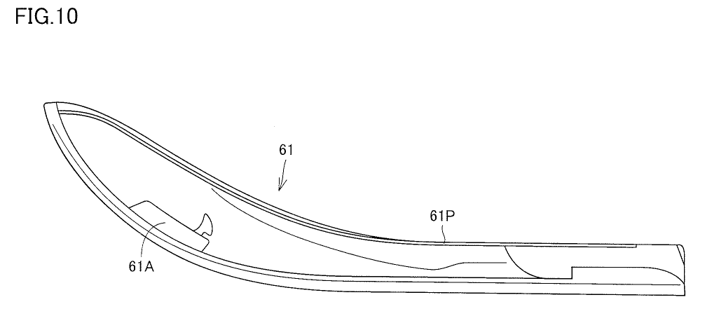

FIG. 9 is a perspective view of exterior cover 61. FIG. 10 is a bottom view of exterior cover 61. FIG. 9 illustrates the perspective view of exterior cover 61 as seen from below. As shown in FIGS. 7, 9, and 10, exterior cover 61 has an upper edge 61E and a plate portion 61P extending downward from upper edge 61E. Upper edge 61E is formed by a sheet-like body having a certain width. Plate portion 61P is joined to the end, on the inner side of the excavator's body, of sheet-like upper edge 61E, and extends from upper edge 61E downward. Plate portion 61P has a thin sheet-like shape.

Plate portion 61P is provided separately from a main body portion of exterior cover 61 that forms the exterior of the excavator's body. The main body portion of exterior cover 61 is joined to the end, on the outer side of the excavator's body, of sheet-like upper edge 61E. The main body portion and plate portion 61P of exterior cover 61 are arranged opposite to each other with a space, which corresponds to the width of sheet-like upper edge 61E, interposed therebetween. Handle 61A is provided on the main body portion of exterior cover 61.

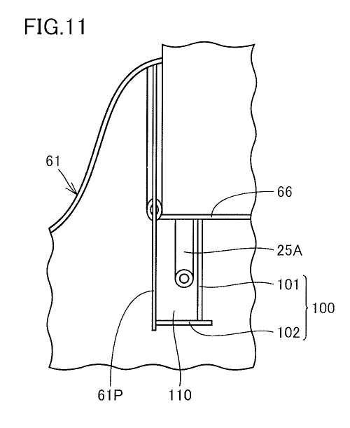

FIG. 11 is a schematic diagram showing a structure of duct portion 110 which houses pipe portion 25A. In FIG. 11, a cross section of hydraulic excavator 1 along a direction orthogonal to the fore/aft direction of the excavator's body, specifically a cross section of a part including duct portion 110 as seen from the front, is schematically illustrated. Exterior cover 61 shown in FIG. 11 is in its closed state. Closed-state exterior cover 61, duct component member 100, and upper step plate 66 of front cover 60 constitute duct portion 110 in the form of a closed space. Duct portion 110 is provided along upper edge 61E of closed-state exterior cover 61.

Duct component member 100 has a vertical member 101 and a horizontal member 102 and is formed to have an L-shaped cross section. Vertical member 101 extends along the vertical direction. The upper edge of vertical member 101 is joined to upper step plate 66. Horizontal member 102 is attached to the lower edge of vertical member 101. Horizontal member 102 extends along the direction which crosses, typically is orthogonal to, the direction in which vertical member 101 extends.

Vertical member 101 is opposite to plate portion 61P of closed-state exterior cover 61 with a space therebetween. Vertical member 101 is arranged in parallel with plate portion 61P in the state where exterior cover 61 is closed. Horizontal member 102 is opposite to upper step plate 66 with a space therebetween. Horizontal member 102 is arranged in parallel with upper step plate 66. In the state where exterior cover 61 is closed, plate portion 61P abuts on an edge of upper step plate 66 and abuts on an edge of horizontal member 102.

Plate portion 61P, upper step plate 66, vertical member 101, and horizontal member 102 form duct portion 110 having a rectangular cross section. Upper step plate 66 forms the upper surface of rectangular duct portion 110. Plate portion 61P forms one lateral surface of rectangular duct portion 110 in the state where exterior cover 61 is closed. Vertical member 101 forms the other lateral surface of rectangular duct portion 110. Horizontal member 102 forms the lower surface of rectangular duct portion 110.

Next, functions and effects of the present embodiment will be described. Hydraulic excavator 1 of the present embodiment includes, as shown in FIG. 4, exhaust gas treatment device 14 treating an exhaust gas from engine 7 through a reduction reaction, and reducing agent tank 20 arranged forward of exhaust gas treatment device 14 and storing reducing agent 90 to be supplied to exhaust gas treatment device 14. Hydraulic excavator 1 further includes, as shown in FIGS. 7 and 8, pipe portion 25A forming a path connecting reducing agent tank 20 and exhaust gas treatment device 14 to each other, duct component member 100 arranged along pipe portion 25A, and openable and closable exterior cover 61 forming a part of a lateral side surface of the body of the excavator. As shown in FIG. 11, exterior cover 61 in the closed state and duct component member 100 form duct portion 110 which houses pipe portion 25A.

Exterior cover 61 which is openable and closable forms a part of the peripheral wall of duct portion 110, and pipe portion 25A is housed inside this duct portion 110. Thus, exterior cover 61 can be opened to expose pipe portion 25A to the outside. Accordingly, accessibility to pipe portion 25A can be improved, which enables easy access to pipe portion 25A when maintenance work such as replacement of pipe portion 25A is necessary.

The path connecting reducing agent tank 20 and exhaust gas treatment device 14 to each other is formed by supply pipe 21 and delivery pipe 25 as shown in FIGS. 4 and 5, and pipe portion 25A forms a part of delivery pipe 25. Pipe portion 25A forms a part of the path in which reducing agent 90, which is supplied from reducing agent tank 20 to exhaust gas treatment device 14, flows. Reducing agent 90 flowing through pipe portion 25A will be deteriorated if the temperature becomes higher. It is therefore necessary to prevent the temperature of reducing agent 90 from increasing.

A part of duct portion 110 in which pipe portion 25A is arranged is formed by exterior cover 61. Thus, duct portion 110 is formed at the position closer to the outside air. The air in duct portion 110 and the outside air exchange heat through exterior cover 61 to thereby suppress overheating of duct portion 110. Accordingly, heat transfer to pipe portion 25A housed in duct portion 110 can be suppressed, and the temperature of reducing agent 90 flowing in pipe portion 25A can be prevented from increasing.

As shown in FIGS. 7, 8, and 11, duct portion 110 is provided along upper edge 61E of exterior cover 61 in the closed state. Exhaust gas treatment device 14 is arranged above the hydraulic pump mounted on revolving frame 31, and located at a position far above revolving frame 31 and close to the ceiling surface of the main body of the hydraulic excavator. Injection nozzle 28 for supplying reducing agent 90 upstream of exhaust gas treatment device 14 is also located at a position far above from revolving frame 31 and close to the ceiling surface of the main body of the hydraulic excavator. Duct portion 110 can therefore be arranged along upper edge 61E of exterior cover 61 to shorten the length of the path connecting reducing agent tank 20 and exhaust gas treatment device 14 to each other.

In addition, pipe portion 25A housed inside duct portion 110 is arranged at a position far from revolving frame 31, and therefore, the distance to pipe portion 25A from main valve 57 mounted on revolving frame 31 can be made large. Because main valve 57 is a heat source generating heat, pipe portion 25A can be arranged at a position far from the heat source to prevent the reducing agent flowing through pipe portion 25A from receiving heat and accordingly deteriorating.

As shown in FIGS. 4 and 8, hydraulic excavator 1 further includes partition plate 80 arranged rearward of reducing agent tank 20. Partition plate 80 defines tank room 92 which houses reducing agent tank 20. The internal space of duct portion 110 directly communicates with tank room 92.

A part of the space on revolving frame 31 is partitioned off by partition plate 80 to form tank room 92. Thus, the internal space of tank room 92 is separated from the heat source. The air inside tank room 92 is therefore kept at a relatively low temperature. Since the internal space of duct portion 110 directly communicates with tank room 92 without another space interposed between the internal space and tank room 92, the internal space of duct portion 110 can be kept at a low temperature. Accordingly, a temperature increase of reducing agent 90 which flows out of reducing agent tank 20 and flows through pipe portion 25A can be suppressed.

Duct component member 100 which forms duct portion 110 together with exterior cover 61 is interposed between pipe portion 25A and high-temperature devices such as main valve 57. Thus, pipe portion 25A can be shielded from the high-temperature devices, and heating of pipe portion 25A due to heat transfer from the heat sources can effectively be suppressed. The internal space of duct portion 110 is formed as a closed space separated from valve room 97 which houses main valve 57. Thus, heating of pipe portion 25A can more reliably be suppressed.

As shown in FIG. 11, duct component member 100 has vertical member 101 opposite to exterior cover 61 with a space therebetween, and horizontal member 102 attached to the lower edge of vertical member 101. In this way, duct component member 100 can be formed with a simple structure and the volume of the internal space of duct portion 110 can be made small.

As shown in FIGS. 7 and 9 to 11, exterior cover 61 has sheet-like plate portion 61P. Plate portion 61P of exterior cover 61 in the closed state and duct component member 100 form duct portion 110 between the plate portion and the duct component member. The main body of exterior cover 61 that forms the exterior of the main body of the hydraulic excavator has a complicatedly curved shape. In view of this, sheet-like plate portion 61P can be provided to simply form duct portion 110 between plate portion 61P and duct component member 100, and make duct portion 110 more compact in structure.

Duct component member 100 is not limited to the L-shaped cross section having vertical member 101 and horizontal member 102. For example, duct portion 110 may be formed between exterior cover 61 and duct component member 100 having an arc-shaped or U-shaped cross section. Alternatively, for example, duct component member 100 may be formed in a flat sheet shape, exterior cover 61 may have a portion having a U-shaped cross section, and the flat sheet-like duct component member 100 and the portion having the U-shaped cross section of exterior cover 61 may form duct portion 110.

As shown in FIG. 1, hydraulic excavator 1 is of a short tail swing type. The area of revolving frame 31 of hydraulic excavator 1 of the short tail swing type is limited, and many devices which are to reach a high temperature have to be arranged on revolving frame 31. In view of this, pipe portion 25A in which reducing agent 90 flows can be housed inside duct portion 110 to thereby suppress heat transfer to pipe portion 25A and accordingly suppress deterioration of reducing agent 90 due to a temperature increase.

It should be construed that the embodiment disclosed herein is given by way of illustration in all respects, not by way of limitation. It is intended that the scope of the present invention is defined by claims, not by the description above, and encompasses all modifications and variations equivalent in meaning and scope to the claims.

### REFERENCE SIGNS LIST

1 hydraulic excavator; 4 work implement; 7 engine; 12, 14 exhaust gas treatment device; 13 intermediate connection pipe; 16 radiator; 17, 18 coolant pipe; 19 coolant pump; 20 reducing agent tank; 21 supply pipe; 22 reducing agent pump; 22A coupling portion; 23 return pipe; 25 delivery pipe; 25A pipe portion; 25B joint; 28 injection nozzle; 31 revolving frame; 36 fuel tank; 38 hydraulic oil tank; 40 heat exchanger; 57 main valve; 58 hydraulic cylinder; 59 oil cooler; 60 front cover; 61 exterior cover; 61A handle; 61B hinge portion; 61E upper edge; 61P plate portion; 62 left side plate; 63 front end plate; 64 lower step plate; 65, 67 standing plate; 66 upper step plate; 68 ceiling plate; 69 vent hole; 70, 120 support column; 71 attachment portion; 80 partition plate; 90 reducing agent; 92 tank room; 97 valve room; 100 duct component member; 101 vertical member; 102 horizontal member; 110 duct portion

1: A hydraulic excavator comprising:
an engine;
an exhaust gas treatment device treating an exhaust gas from said engine through a reduction reaction;
a reducing agent tank arranged forward of said exhaust gas treatment device and storing a reducing agent to be supplied to said exhaust gas treatment device;
a pipe forming a path connecting said reducing agent tank and said exhaust gas treatment device to each other;
a duct component member arranged along said pipe; and
an openable and closable exterior cover forming a part of a lateral side surface of a body of the excavator,
said exterior cover in a closed state and said duct component member form a duct portion which houses said pipe.

2: The hydraulic excavator according to claim 1, wherein
said duct portion is provided along an upper edge of said exterior cover in the closed state.

3: The hydraulic excavator according to claim 1,
further comprising a partition plate arranged rearward of said reducing agent tank, said partition plate defining a tank room housing said reducing agent tank, wherein
an internal space of said duct portion directly communicates with said tank room.

4: The hydraulic excavator according to claim 1, wherein
said duct component member has a vertical member opposite to said exterior cover with a space therebetween and a horizontal member attached to a lower edge of said vertical member.

5: The hydraulic excavator according to claim 1, wherein
said exterior cover has a sheet-like plate portion, and
said plate portion of said exterior cover in the closed state and said duct component member form said duct portion between said plate portion and said duct component member.

6: The hydraulic excavator according to claim 1, wherein
said hydraulic excavator is of a short tail swing type.

7: The hydraulic excavator according to claim 2, further comprising a partition plate arranged rearward of said reducing agent tank, said partition plate defining a tank room housing said reducing agent tank, wherein
an internal space of said duct portion directly communicates with said tank room.

8: The hydraulic excavator according to claim 2, wherein
said duct component member has a vertical member opposite to said exterior cover with a space therebetween and a horizontal member attached to a lower edge of said vertical member.

9: The hydraulic excavator according to claim 3, wherein
said duct component member has a vertical member opposite to said exterior cover with a space therebetween and a horizontal member attached to a lower edge of said vertical member.

10: The hydraulic excavator according to claim 7, wherein
said duct component member has a vertical member opposite to said exterior cover with a space therebetween and a horizontal member attached to a lower edge of said vertical member.

11: The hydraulic excavator according to claim 2, wherein
said exterior cover has a sheet-like plate portion, and
said plate portion of said exterior cover in the closed state and said duct component member form said duct portion between said plate portion and said duct component member.

12: The hydraulic excavator according to claim 3, wherein
said exterior cover has a sheet-like plate portion, and
said plate portion of said exterior cover in the closed state and said duct component member form said duct portion between said plate portion and said duct component member.

13: The hydraulic excavator according to claim 4, wherein
said exterior cover has a sheet-like plate portion, and
said plate portion of said exterior cover in the closed state and said duct component member form said duct portion between said plate portion and said duct component member.

14: The hydraulic excavator according to claim 7, wherein
said exterior cover has a sheet-like plate portion, and
said plate portion of said exterior cover in the closed state and said duct component member form said duct portion between said plate portion and said duct component member.

15: The hydraulic excavator according to claim 8, wherein
said exterior cover has a sheet-like plate portion, and
said plate portion of said exterior cover in the closed state and said duct component member form said duct portion between said plate portion and said duct component member.

16: The hydraulic excavator according to claim 9, wherein
said exterior cover has a sheet-like plate portion, and
said plate portion of said exterior cover in the closed state and said duct component member form said duct portion between said plate portion and said duct component member.

17: The hydraulic excavator according to claim 10, wherein
said exterior cover has a sheet-like plate portion, and
said plate portion of said exterior cover in the closed state and said duct component member form said duct portion between said plate portion and said duct component member.
